(19) United States
(12) Patent Application Publication
(10) Pub. No.: US 2006/0069579 A1
(43) Pub. Date: Mar. 30, 2006

(54) Method of monitoring a facility

(75) Inventors: Norbert Grass, Herzogenaurach (DE); Thorsten Riemer, Baiersdorf (DE); Theodor Rosch, Oberotterbach (DE); Klaus Ruiner, Hainburg (DE); Matthias Seifert, Buchholz (DE); Gerhard Weller, Erlangen (DE)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 10/952,625

(22) Filed: Sep. 29, 2004

(51) Int. Cl. G06Q 99/00

(52) U.S. Cl. 705/1

(57) ABSTRACT

The present invention provides an efficient and simple method of monitoring a facility including entertainment functionality, wherein a first data set relevant to operational purposes of the facility is acquired and a second data set relevant to entertainment purposes is inputted. After selecting either the first or the second data set, the selected data set is processed and output. The processed data set is preferably transmitted to an output device over an at least two-channel transmission device, wherein the first and the second data set are assigned separate channels.

### FIELD OF THE INVENTION

The present invention relates to a method of operating a monitoring system of a facility.

### BACKGROUND OF THE INVENTION

Modern facilities to be monitored are often highly automated including an enormous amount of data to be transmitted to and displayed at a variety of locations. A power plant for power generation or any other industrial plant, for example, usually comprise a number of sensors, actuators and programmable logic controllers connected to a higher level computer based monitoring system.

### SUMMARY OF THE INVENTION

Besides the above mentioned industrial plants, there are, for example, passenger trains and hotels, which employ monitoring systems that identify all data relevant to an operational condition of the facilities available at a centralized location, for example at a board computer or a Personal Computer including a computer screen and audio output means.

The operators of such facilities are thus enabled to easily obtain all relevant information anytime.

More recently, even private facilities such as houses and cars tend to become more and more automated, sometimes even including a “control room” for monitoring purposes.

Especially as far as facilities such as hotel rooms, passenger trains and cars are concerned, where people usually are not permanently at work or doing business, there is a need for recreational activities and entertainment. Just imagine a family man traveling a long distance with his family on holidays by car.

Even at facilities such as industrial plants, the operators sometimes have nothing to do and are getting bored which has negative effects on their alertness.

The present invention provides a simple and effective method of operating a monitoring system of a facility to address such needs for distraction or entertainment.

One aspect of the invention thus involves a concept of selecting either a first data set relevant to operational purposes of the facility or a second data set relevant to entertainment purposes. The selected data set is then processed and output.

The second data set preferably includes audio data, video data, DVD, CD, URL internet addresses and telecommunication data such as telephone numbers.

The processed data are preferably transmitted to the output device over a two-channel transmission device so that processed data are either transmitted over a first or a second of the at least two transmission channels depending on the processed data being related to operational or entertainment purposes. An identification parameter can be used to identify the type of the processed data set.

A current value of a status parameter related to an operational status of the facility is evaluated to determine if an ongoing output of processed data shall be suspended because of a current operational status of the facility requiring attention of an operator.

The first and second transmission channel can be realized by two separate physical installations such as wires or a two channel data bus. It can also be realized by a two channel radio transmission wherein each of the first and second data set uses a different transmission frequency. In principle, the data sets are processed resulting in a first and a second data stream, the data streams not interfering with each other.

A further aspect of the present invention thus involves an monitoring system for monitoring a facility comprising:

at least one data acquisition device for acquiring a first data set relevant to operational purposes of the facility;

at least one data input device for inputting a second data set relevant to entertainment purposes;

at least one selecting device for selecting either the first or the second data set;

at least one processing device for processing the selected data set;

at least one transmission device for transmitting the processed data set; and

at least one output device for outputting the transmitted data set.

A transmitting device for transmitting the processed data set to the output device preferably includes at least two transmission channels so that the first and the second data set can be transmitted over separate channels. As already stated, the transmission channels can be realized by two separate physical installations such as wires or a two channel data bus. It can also be realized by a two channel radio transmission wherein each of the first and second data set uses a different transmission frequency. In principle, the data sets are processed resulting a first data stream related to the first data set and a second data stream related to the second data set, the data streams not interfering with each other.

An identification parameter can be used to identify the type of the processed data. Furthermore, a current value of a status parameter related to an operational condition of the facility is evaluated to determine if an ongoing output of processed data shall be suspended because of a current operational condition of the facility requiring attention of an operator.

The proposed method and system provides for a multiple use of the monitoring system for monitoring the facility and entertainment purposes, whereby at least some components of the monitoring system are shared among monitoring and non-monitoring, especially entertainment, applications. Thus, set up of an expensive separate entertainment system may often be unnecessary.

Furthermore, the acceptance of a multiple-purpose monitoring system and its use among prospective customers is enhanced as customers are often more willing to invest in entertainment equipment rather than in advanced monitoring devices without any additional features. The invention allows for getting all-in-one.

Further aspects, features and advantages of the present invention will become apparent from the drawings and detailed description of the following preferred embodiments.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings and wherein:

FIG. 1 is a flowchart of an exemplary process of the present invention showing an exemplary series of steps of monitoring a facility, and

FIG. 2 is a schematic diagram of a computer system adapted to enable an embodiment of the invention.

### DETAILED DESCRIPTION OF THE PREFERRED EMBODIMENT

Overview

The disclosed invention advantageously employs one or more base concepts.

It basically provides an efficient and simple method of monitoring a facility including acquiring a first data set relevant to operational purposes of the facility, inputting a second data set relevant to entertainment purposes, selecting either the first or the second data set, processing the selected data, and outputting the processed data on an output device, wherein the processed data are transmitted to the outputting means over a preferably two-channel transmission device with the above mentioned first data set being allocated to a pre-defined channel.

The first data set related to operational purposes of the facility includes data influencing the proper operation of the facility such as sensor data originating at components of the facility, for example fluid pressures, bearing temperatures, engine temperature, coolant temperatures, environmental temperatures, electric currents, electric voltages, switch settings, relay trips, closed/open status of doors, valves and so on. Those data indicate if the facility's components work well.

The second data set is input by a user of the monitoring system. This second data set relates to entertainment purposes and includes only data which have no influence on a proper operation of the facility, such as (facility independent) audio or video data, DVD, CD, telephone and internet. They aim at providing an operator, visitor, guest or passenger of the facility with recreation, relaxation and distraction.

The input of the second data set (for example an URL Internet Address) does not require to start a specialized application program (e.g. an Internet Browser) first. That means that the input device for inputting the second data set is not part of a specialized application program which further processes the second data set.

One concept, therefore, is selecting from at least two different data sources, either from the first or the second data set.

Another concept involves employing at least two separate transmission channels over which the selected and processed data sets are transmitted so that they cannot interfere which each other.

Furthermore, the selected data set preferably is assigned a pre-defined transmission channel depending on the type of the selected and processed data set.

Yet another concept makes use of evaluating a status parameter which reflects a current operational condition of the facility. Depending on a current value of the status parameter, output of processed data shall be suspended, if, for example, an operator is currently watching an entertainment program, but the facility requires attention because of an alarming operational condition. In that case, displaying the entertainment program is suspended automatically and the data set relevant to the facility comes on focus and is displayed instead.

All the embodiments to be described in more detail in the following can be applied to monitoring systems for all kinds of facilities such as industrial plants, hotels, passenger trains, cars etc. and shall not be limited to any special system for a special purpose.

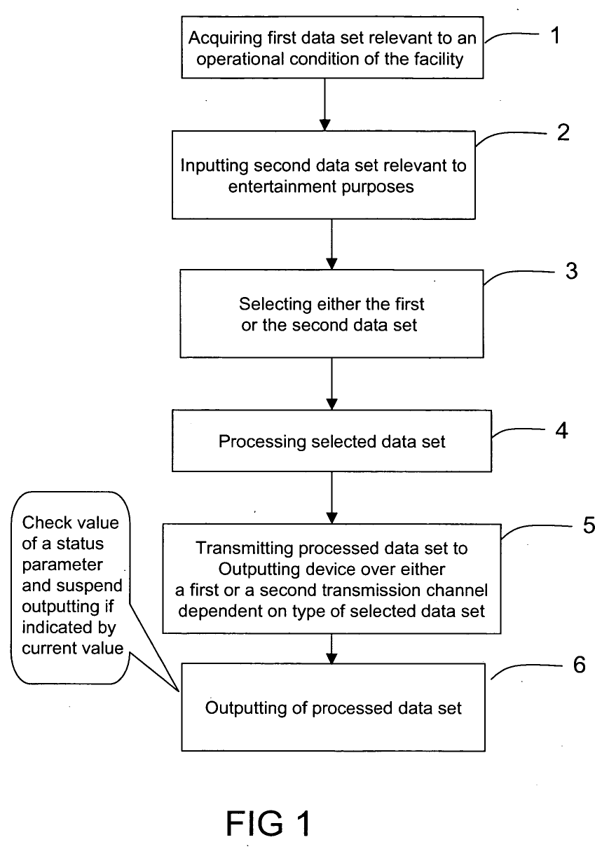

FIG. 1 depicts a flowchart showing a series of exemplary steps that can be performed to monitor a facility according to the invention.

Step 1 provides acquiring a first data set relevant to operating the facility, which can be accomplished by sensors and local Programmable Logic Controllers (PLCs) mounted within the facility or by smart sensors which include at least some data preprocessing.

Step 2 allows for inputting a second data set which is not related to operating the facility, for example DVDs, CDs, Video or Audio Tapes, URL internet addresses or telephone numbers to be dialed. The second data set is only relevant to entertainment purposes to provide an operator or other persons involved in using the facility with recreation, relaxation and distraction. Those other persons are for example children sitting in the back seats of a vehicle.

In Step 3 and 4 it is decided which of the first or second data set shall be processed for outputting by means of selecting the related data. So anyone involved in operating or using the monitoring system can decide whether information on a current operational status of the facility shall be requested or if he/she prefers being entertained instead.

Step 5 provides transmitting the selected and processed data set over either a first or a second transmission channel, for example a wire or radio based system. Data relevant to the facility can be allocated a designated transmission channel while entertainment data shall be transmitted over another transmission channel so that important (facility related) and other data (entertainment related) cannot interfere with each other.

The channel to which facility related data have been allocated is preferably adapted to transmit data reliably (e.g. by employing redundancy concepts) and/or securely (e.g. by employing encryption methods).

Such a separation of data streams being transmitted over the transmission channels enhances the functionality of the monitoring system as a reliable monitoring system with emphasis laid on processing and transmitting facility related data, with entertainment functionality provided as an add-on.

The selected and processed data are finally output in step 6 for example on a computer screen, a large screen or a projection system.

To efficiently maintain the monitoring system's monitoring capabilities and provide for a safe operation of the facility, a status parameter related to an operational status of the facility is evaluated to decide if data output is suspended. For example, displaying of a DVD movie is suspended automatically if facility requires attention (because of a warning message, an alarm, a report of a critical status etc.); in that case, the data set relevant to operating the facility is displayed instead to immediately attract the attention of an operator.

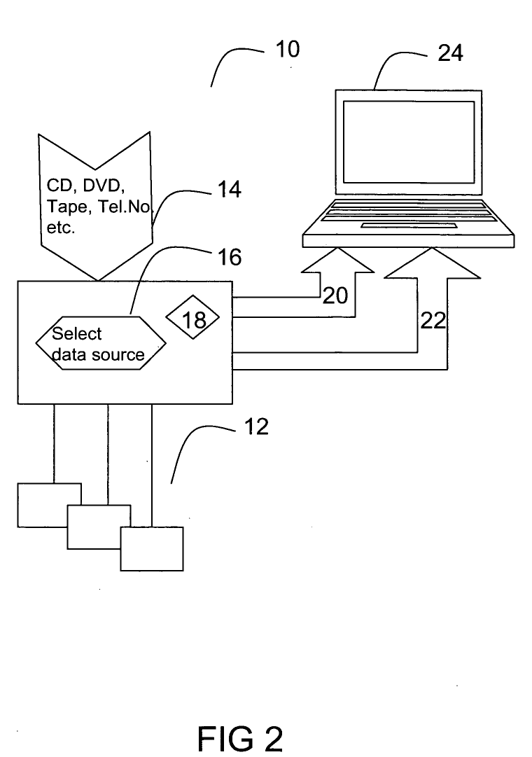

FIG. 2 schematically illustrates a monitoring system 10 which enables an embodiment of the invention.

The system 10 represents a monitoring system for example of an industrial plant including a number of sensors and Programmable Logic Controllers 12 to acquire data relevant to an operational condition of the plant such as temperatures, pressures, settings of switches and valves and the like.

Furthermore, it includes an input device 14 for inputting other data not relevant to the plant such as DVDs, CDs, Video Tapes, Audio Tapes, telephone numbers etc.

An operator selects from the above mentioned data sources by applying a selecting device 16 so that facility and/or other data can be processed and transmitted to an output device 24, for example a laptop computer or a large screen device.

A processor for processing the selected data set is included and can be realized, for example, by a CPU (Central Processing Unit) or a Co-Processor which are programmed to process the selected data set according to its type.

An identification parameter is used to differentiate between the first and the second data set. The processor, for example, assigns the identification parameter a designated value depending on the type of the data set (facility related versus non facility related).

If, for example, the selected data set relates to bearing temperatures of an engine of the facility, the processor is programmed to calculate and/or display temperature trend curves, display lower and upper limits for this temperature and generate messages according to a current value of this temperature.

If, on the other hand, the selected data set relates to, for example, an input of a telephone number, it is programmed to automatically call a dialer program and establish a telephone connection. A further example is the input of an internet address (URL), upon which the processor is programmed to automatically call an Internet Browser to open. Therefore, an input of all types of data related to entertainment purposes does not require starting or opening a specialized application program first before the data set can be input in that specialized application and processed.

The selecting device 16 is for example a hardware switch or a software based switch such as a control panel window including radio buttons, push buttons or check boxes. In case of a software based switch, the switch is preferably included in a touch screen display. Alternatively, the switch can be operated by a computer mouse or light pen or by means of a voice recognition device which analyzes the operator's speech input.

Additionally, a control device 18 is provided to evaluate a status parameter related to an operational status of the facility, so that a current display of non facility related data can be automatically suspended if the facility requires attention. Data relevant for operating the facility will be automatically displayed instead to attract the operator's immediate attention.

Transmission channels 20 and 22 are provided for transmitting the selected data to the output device 24.

A designated channel of channels 20 and 22 is allocated to facility related data so that those data can be reliably transmitted; therefore the designated channel is preferably further enhanced by employing redundancy and/or security concepts.

Other data use the other channel of channels 20 and 22 for transmission.

In case one of channels 20 and 22 fails, selection of non-facility related data shall be disabled and facility related data shall be transmitted over the remaining fully functional channel. This automatic disabling can also be conducted by evaluating the before mentioned status parameter, if it has been assigned a designated value after detecting the transmission channel failure.

In addition to the embodiments of the aspects of the present invention described above, those of skill in the art will be able to arrive at a variety of other arrangements and steps which, if not explicitly described in this document, nevertheless embody the principles of the invention and fall within the scope of the appended claims.

For example, the ordering of method steps is not necessarily fixed, but may be capable of being modified without departing from the scope and spirit of the present invention.

What is claimed is:

1. A method of monitoring a facility including data having at least a first data set relevant to operational purposes of the facility and a second data set relevant to entertainment purposes of an individual within the facility, the method comprising:
acquiring the first data set;
inputting the second data set into a data input device;
selecting either the first or the second data set;
processing the selected data set; and
outputting the processed data set.

2. The method according to claim 1, wherein the processed data set is transmitted to an output device over a first or a second of at least two transmission channels.

3. The method according to claim 2, wherein the processed data set is transmitted over the first transmission channel if the processed data set is related to operational purposes of the facility and over the second transmission channel if the processed data set is relevant to entertainment purposes.

4. The method according to claim 3, wherein the first and the second transmission channels are located at physically separated installations.

5. The method according to claim 1, wherein each of the first and the second data set are processed to provide a first respectively second data stream.

6. The method according to claim 1, wherein the outputting of the processed data set is controlled by a status parameter related to a current operating status of the facility.

7. The method according to claim 6, wherein a current value of the status parameter is analyzed and the outputting of the processed data set is suspended if the processed data set is related to entertainment purposes and the current value of the status parameter equals or exceeds or drops below a predefined value or falls into a predefined value range.

8. The method according to claim 1, wherein the second data set is selected from the group consisting of audio data, video data, telecommunication data and data in URL-format.

9. An monitoring system for monitoring a facility comprising:
at least one data acquisition device for acquiring a first data set relevant to operational purposes of the facility;
at least one data input device for inputting a second data set relevant to entertainment purposes of an individual within the facility;
at least one selecting device for selecting either the first or the second data set;
at least one processing device for processing the selected data set;
at least one transmission device for transmitting the processed data set; and
at least one output device for outputting the transmitted data set.

10. The system according to claim 9, wherein the transmission device includes at least a first and a second data transmission channel and the processed data are transmitted to the output device either over the first or the second transmission channel.

11. The system according to claim 10, wherein the processed data are transmitted over the first transmission channel if the processed data are relevant to operational purposes of the facility and over the second transmission channel if the processed data are relevant to entertainment purposes.

12. The system according claim 11, wherein the first and the second transmission channel are physically separated installations.

13. The system according to claim 11, wherein each of the first and the second data set are processed resulting in a first respectively second data stream.

14. The system according to claim 9, further including at least one control device including a status parameter for controlling the outputting of the transmitted data set, wherein the status parameter is related to an operational status of the facility.

15. The system according to claim 14, wherein the outputting of the transmitted data is suspended if the transmitted data are relevant to entertainment purposes and a current value of the status parameter equals or exceeds or falls below a predefined parameter value or falls into a predefined parameter range.

16. The system according to any of claims 9, wherein the second data set includes any of audio data, video data, telecommunication data and data in URL format.

17. A method of monitoring a facility, the method comprising:
providing a monitoring system having an output screen for monitoring the facility; and
modifying the monitoring system so that the monitoring system is adapted to process a second data set relevant to entertainment purposes of an individual within the facility and the output screen can output the processed data set,
wherein a first data set includes data relevant to operational purposes of the facility.

18. The method according to claim 17, wherein the first and the second data set are transmitted to the output screen over separate transmission channels.

19. The method according to claim 17, wherein the outputting of the processed data set is controlled by a status parameter related to an operational status of the facility.
